(19) United States
(12) Patent Application Publication
(10) Pub. No.: US 2015/0100525 A1
(43) Pub. Date: Apr. 9, 2015

(54) METHOD AND SYSTEM FOR THE DETECTION OF ANOMALOUS SEQUENCES IN A DIGITAL SIGNAL

(71) Applicant: UNIVERSIDADE DE AVEIRO, Aveiro (PT)

(72) Inventors: Fernão Rodrigues Vistulo De Abreu, Aveiro (PT); Patrícia Maria Mostardinha Silva, Aveiro (PT); Bruno Filipe Dos Santos Faria, Aveiro (PT)

(73) Assignee: UNIVERSIDADE DE AVEIRO, Aveiro (PT)

(21) Appl. No.: 14/382,383

(22) PCT Filed: Mar. 4, 2013
(86) PCT No.: PCT/IB2013/051706

§ 371 Date: Sep. 2, 2014

(30) Foreign Application Priority Data
Mar. 2, 2012 (PT) 106185

(51) Int. Cl. G06N 5/04; G06N 99/00

(52) U.S. Cl. CPC G06N 5/04; G06N 99/005
USPC 706/12

(57) ABSTRACT

Method and system for the detection of anomalous behavior in systems displaying typical and complex behavior encoded in a digital signal through the study of a computational model (artificial system) of interacting agents defined using the information contained in the digital signal and imposing that agents engage in a maximally frustrated dynamics. Changes in the target system's behavior lead a measurable decrease in frustration of the artificial system, from sequences never presented before during the system's normal behavior or combinations of already presented sequences never seen together.

### TECHNICAL DOMAIN OF THE INVENTION

The present invention concerns the detection of anomalous behavior in systems displaying a typified complex behavior, encoded in a digital signal, through the study of a computational model (the artificial system) of interacting agents defined using information contained in the digital signal and forcing agents to engage in a maximally frustrated dynamics.

### PRIOR ART

The detection of anomalous behavior in systems with a typical complex behavior is a difficult task given the wide variety of behaviors that can characterize the system's typical behavior, as well as the wide variety of possible anomalous behavior. The difficulty is related to the difficulty in developing methods that are autonomous, precise and that can find a large range of potential applications.

There are essentially two types of methods: 1) detection of anomalies using statistical or spectral analysis of the system's behavior; 2) intrusion detection through the detection of unfamiliar elements.

The book [2] presents methods of type 1. These methods require that anomalies have an impact in the statistics characterizing the system's behavior. They use, in general, the past behavior of the system to establish a profile of normality. Given the statistical nature of these methods, the number of undetected anomalies (false negatives) is large, because these methods require time to react. These methods have also difficulty in distinguishing if statistical fluctuations represent anomalies or legitimate behavior (the number of false positives is also large). These methods have nevertheless the advantage of being able to detect intrusions that share features in common with the legitimate system's behavior. For instance, they can detect the use of an excessive frequency of a sequence usually present but with less frequency. However, these analyses have to be implemented specifically for each case. The present invention has the advantage of producing this type of detections but using self-organized mechanisms, which allows analyzing a considerably larger number of correlations without requiring input information from a user. The method produces in the same circumstances, small amount of errors.

Another possible approach consists in using non-parametric tests—for instance, Kolmogorov-Smirnov, or Anderson-Darling—to evaluate if a sample from the signal deviates significantly from the behavior that could be predicted from the probability distribution characterizing the system's typical behavior. Relatively to these methods, the present invention has the advantage of detecting spatial correlations (within samples) and dynamical correlations (evolving in time), which cannot be accessed with the previous methods.

Type 2 methods can be divided in two types. Methods for the detection of anomalous behavior already experienced and registered in a database (based on ‘signatures’), or methods for detecting behavior never registered before. The first type of methods is commonly used in commercial antivirus. However, their databases tend to grow fast because the number of possible intrusion variants grows exponentially with the number of small changes that could be present. For this reason, these methods require considerable resources, not only in memory but also in computational time. Besides, as databases must be kept within reasonable limited sizes, these methods require continuous updates to consider new threats at the cost of neglecting older ones. These methods are necessarily vulnerable and they require the prior knowledge of possible anomalies. Hence, they cannot avoid damages from anomalies that have never been registered before.

Unlike, the present invention does not require the previous knowledge of potential anomalies and for that reason it does not have this type of vulnerabilities. Moreover, the number of potential intrusions that it can detect is considerably larger.

The present invention is closer to a second type of methods [1]. In documents [3-8] are discussed the most recent developments of this method class, designated as negative selection methods. Similarly to the present invention, negative selection algorithms assume that the system's normal behavior can be encoded in a digital signal. From this signal, smaller sequences are defined. The set of these sequences defines the profile of the system's normal functioning (designated ‘self’).

Negative selection methods use a so-called negative selection trial and error process to define detection domains that do not contain sequences from the original data signal. A detector is associated to each detection domain. The goal is to define a set of detection domains covering the whole set of sequences not present in the original signal.

When a new data series is tested, the algorithm detects anomalies if a sequence extracted from the new data series belongs to a detection domain defined before. In that case the algorithm signals the detection of a foreign sequence or an abnormal behavior. These algorithms lead to two types of errors. One results from the difficulty in defining detection domains that cover the whole space of foreign sequences. Errors of this type cannot be avoided with these methods. However, some techniques have been developed to guarantee that this type of errors do not exceed 5% of the foreign possible sequences. This requires increasing the total number of detectors. It has, nevertheless been noted that this difficulty cannot be overcome when sequences use a large number of digits. In that case, the number of required domains diverges, making these methods unfeasible. On the contrary, the present invention performs perfect detection even in that case.

The second type of errors results from the fact that these methods are blind to presence of sequences that occur in the original signal with an ordering or frequency different from that in the original signal. Unlike, the present invention detects anomalies of this kind. This is due to the fact that the method of detection in the present invention is based on conceptually different mechanisms. It should be mentioned that it is likely that the majority of successful intrusions in computer systems belong to anomalies of this type, and for this reason the present invention is particularly relevant.

The present invention belongs to the previous type of methods because it uses a series of digital signals to build a set of sequences that define the normal behavior of the system to protect. Moreover, it also uses a negative selection procedure to define detectors. However, this invention works in a conceptually different way, as it will become apparent next.
[1] L. Allen, S. Forrest, and A. S. Perelson “A method of detecting changes to a collection of digital signals.” U.S. Pat. No. 5,448,668 (Sep. 5, 1995).
[2] Wang, Y., Statistical Techniques for Network Security: Modern Statistically-Based Intrusion Detection and Protection. IGI Global ed. 2009.
[3] Dasgupta, D., Advances in artificial immune systems. Ieee Computational Intelligence Magazine, 2006. 1(4): p. 40-49.
[4] Dasgupta, D., S. H. Yu, and F. Nino, Recent Advances in Artificial Immune Systems: Models and Applications. Applied Soft Computing, 2011. 11(2): p. 1574-1587.
[5] Forrest, S., et al., Self-Nonself Discrimination in a Computer. 1994 Ieee Computer Society Symposium on Research in Security and Privacy, Proceedings, 1994: p. 202-212.
[6] Stibor, T., P. Mohr, and J. Timmis, Is negative selection appropriate for anomaly detection? GECCO 2005: Genetic and Evolutionary Computation Conference, Vols 1 and 2, 2005: p. 321-328.
[7] Forrest, S., et al., A sense of self for unix processes. 1996 Ieee Symposium on Security and Privacy, Proceedings, 1996: p. 120-128.
[8] Timmis, J., et al., Theoretical advances in artificial immune systems. Theoretical Computer Science, 2008. 403(1): p. 11-32.

### SUMMARY OF THE INVENTION

The goal of the present invention is to detect anomalies using sequences from a data set describing a system's behavior.

The present invention uses sequences defined from a digital signal to build the profile of a system's typical behavior. It can be used to detect unfamiliar sequences or unfamiliar combinations of familiar sequences.

Thus it can be used to develop systems dedicated to the detection of anomalies and intrusions in computer systems, the detection of coding errors in DNA or abnormal protein sequences, the detection of tumors using medical imaging or the detection of unfamiliar substances and for quality control or authenticity checking using spectroscopy, among others.

The invention operates in three stages: education of a repertoire of detectors, calibration and detection. During the repertoire education stage, the invention uses sequences characterizing the system's normal behavior—called target system—to define interacting agents in a computational model (artificial model). The calibration stage uses agents defined as in the education stage to compute parameters defining the target system normal behavior. During the detection stage, changes in the target system behavior produce measurable changes in the agent's behavior in the artificial system which signals in this way the presence of anomalies.

Comparing with the prior art, instead of triggering responses depending on whether sequences fall within detector's domains, the present invention establishes an interaction dynamics involving detectors and uses their dynamical properties to signal anomalies.

Besides a negative selection process, the present method uses as well a positive selection process during repertoire the education stage, and in which detectors that cannot establish contacts are eliminated.

### GENERAL DESCRIPTION OF THE INVENTION

The invention describes a system and a general method of detection of anomalous behaviors for systems with a typical behavior described by a digital signal.

It is described how to detect deviations from the target system normal behavior by studying a computational model (artificial system) of interacting agents. The computational model is a kind of cellular automaton that uses a new type of rules to update the system's agent (or cell) states.

In the present invention, agents in the artificial system are defined using the information contained in the digital signal and by imposing that they engage in a maximally frustrated dynamics. In that way, changes in the target system behavior lead to a measurable decrease in frustration in the artificial system dynamics. The method detects perfectly any sequence that has never been produced by the target system normal behavior. It also detects combinations of already presented sequences that had not been presented before.

The invention works as a sophisticated non parametric statistical test, that is capable of detecting deviations from an arbitrary probability distribution and spatial correlations (i.e., within sequences from the signal) and dynamical correlations (that can evolve in time).

The invention can be applied to intrusion detection in computer security, to the analysis of data in genomics and proteomics, in spectroscopy, in image processing, in medicine and economics.

### BRIEF DESCRIPTION OF THE DRAWINGS

For an easier understanding of the invention attached are the figures, which represent preferred embodiments of the invention, which, however, are not intended to limit the object of this invention.

FIG. 1: Schematic representation of the system and method thereof which is implemented in three stages education/training, calibration and detection. In all of them the dynamics of interactions between two types of agents—detectors and presenters—is analyzed.

FIG. 2: Schematic representation of the several steps in the algorithm in which 3 stages can be distinguished, repertoire education, calibration and detection and where: in the repertoire education stage, sequences are obtained from a complex training signal (without anomalies), defining agents (step 2E), applying a dynamical selection process (steps 4E, 5E and, 6E or 6E*), and repeating the process until the stopping criterion A is fulfilled, reaching step 7E, and repeating the whole procedure until the whole repertoire is formed, as established in step 8E; in the calibration stage, sequences are obtained from a training complex system (without anomalies) and agents are defined (steps 1C and 2C), agents engage in the detection dynamics with anergy (steps 4C and 5C), and the whole process is repeated until a predefined number of iterations is reached (stopping criterion B), after which normality parameters are determined (step 7C);

in the detection stage, sequences are obtained from a signal from the complex system to be tested (possibly with anomalies) and agents are defined (steps 1D and 2D), agents engage in the detection dynamics with anergy (steps 4D and 5D), the number of long contacts is calculated (step 6D), and the whole process is repeated until the predefined number of iterations is reached (stopping criterion C), after which the computed dynamical parameters are compared with the corresponding parameters registered during the calibration stage (step 8D), possibly triggering an alarm signal (stopping criterion D);

FIG. 3: Schematic representation of the several steps in the repertoire education stage, namely

A: the mapping of the complex behavior of a system, or of a digital signal, in sequences where (001011100111010) represents the original digital signal,
(A) represents a sequence,
(B) represents a sequence, and
(C) represents a sequence.
B: the definition of the initial population of agents where (presenters) represent presenter agents;
(detetors) represent detector agents;
(A), (B) and (C) represent presenter agents presenting respectively sequences (A), (B) and (C);
(ligand) represents each agent's ligand;
(receptor) represents each agent's receptor;
(cluster1) and (cluster2) represent groups, clusters of agents, and
the dashed line represents presenter agent A connectivity list.
C: agents interaction dynamics where
(decisions) represents the creation of a new pair, even if the agent was already paired, provided that improves its preference.
D: the definition of successive populations of detector agents after positive and negative selection and the creation of the repertoire.

FIG. 4: Schematic representation of the several steps in the calibration stage, including namely

A: the mapping of the complex behavior of a target training system, or of a digital signal, in sequences where (001011100111010) represents the original digital signal,
(A) represents a sequence,
(B) represents a sequence, and
(C) represents a sequence.
B: the definition of the initial population of agents where (presenters) represent presenter agents;
(detetors) represent detector agents;
(A), (B) and (C) represent presenter agents presenting respectively sequences (A), (B) and (C);
(ligand) represents an agent's ligand;
(receptor) represents an agent's receptor;
(cluster1) and (cluster2) represent groups, clusters of agents, and
the dashed line represents presenter agent A connectivity list.
C: the agents interaction dynamics where
(decisions) represents the creation of a new pair, even if any of the agent was already paired, provided it improves his preference.
(anergy) represents the substitution of a detector agent with another equivalent agent in population X from the repertoire, whenever it terminates a pairing that lasted for a time τ larger than a pre-established time τₐ, without forming new pairings.
D: the evaluation of parameters that defined the dynamics of the system in the absence of anomalies (normality) namely
T_{det}(I), the duration of the longest contacts in which presenter agent I participated;
Tᵢₙₐₜ(I), the duration of the longest periods of time during which agent I did not establish any new pairing;
n_{det}(I), the number of pairings established by a presenter agent I and lasting T_{det}(I) in a given time interval;
nᵢₙₐₜ(I), the number of periods of time with a duration equal or larger than Tᵢₙₐₜ(I) and during which presenter agent I could not form a new pairing;

FIG. 5: Schematic representation of the several steps in the detection stage, including namely

A: the mapping of the complex behavior of a system to test, or of a test digital signal, in sequences where (001011100111010) represents the original digital signal,
(A) represents a sequence,
(B) represents a sequence, and
(C) represents a sequence.
B: the definition of the initial population of agents where (presenters) represent presenter agents;
(detetors) represent detector agents;
(A), (B) and (C) represent presenter agents presenting respectively sequences (A), (B) and (C);
(ligand) represents an agent's ligand;
(receptor) represents an agent's receptor;
(cluster1) and (cluster2) represent groups, clusters of agents, and
the dashed line represents presenter agent A connectivity list.
C: the agent's interaction dynamics where
(decisions) represents the creation of a new pair, even if any of the agent was already paired, provided it prefers the new pairing;
(anergy) represents the substitution of a detector agent with another equivalent agent in population X from the repertoire, whenever it terminates a pairing that lasted for a time τ larger than a pre-established time τₐ, without forming new pairings.
D: the evaluation of parameters which define the dynamics of the system to be tested and comparison with the parameters found for the system in the absence of anomalies, and activation or not of an alarm system, and where namely
n_{cos}(I) is the number of pairings established by presenter agent I and lasting T_{det}(I) during the detection stage;
n_{det}(I), is the number of pairings established by presenter agent I and lasting T_{det}(I) during the training stage;
nₐᵤₛ(I), is the number of periods of time with a duration larger or equal to Tᵢₙₐₜ(I) during which presenter agent I was not capable of establishing a pairing during the detection stage;
nᵢₙₐₜ(I), is the number of periods of time with a duration larger or equal to Tᵢₙₐₜ(I) during which presenter agent I was not able to establish a pairing during the training stage.

FIG. 6A: Representation of pairing lifetimes in the beginning of the education stage.

FIG. 6B: Representation of pairing lifetimes in the end of the education stage.

FIG. 6C: Representation of pairing lifetimes for the presentation of a sequence that was never presented before, anomalous.

FIG. 6D: Representation of pairing lifetimes for the presentation of an anomalous combination of already presented sequences (bold dark), compared with the same curves during training (light).

### DETAILED DESCRIPTION OF THE INVENTION

The present invention detects anomalies in the behavior of a target system using digital data series. It is assumed that a data series or a data set is available with the necessary information about the typical complex behavior of the system. From them, sets with sequences with a fixed number of digits can be defined. The method relates the information contained in the set of sequences, with the behavior of a computational model (artificial system) of interacting agents. The computational model is a new type of cellular automaton in which agent's states evolve dynamically following rules that make use of a temporal component associated to agent's states.

Agents in the artificial system are defined using sequences from the original data series and in such a way as to engage in a maximally frustrated dynamics. Changes in the behavior of the target system decrease the frustration in the artificial system which can be measured and used to trigger the detection system. The way in which sequences can be defined from the original data can be diverse. The method establishes how these sequences can be used to detect sequences that were absent from the original (training) signal or to detect sequences that had already been present but appear in new combinations.

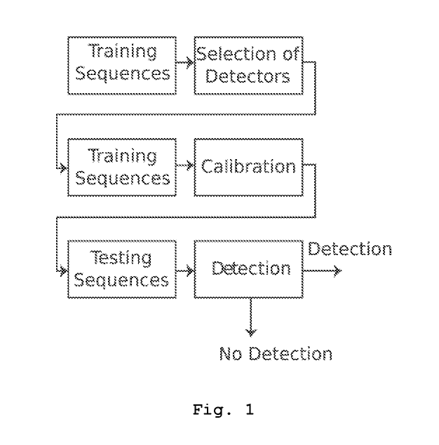

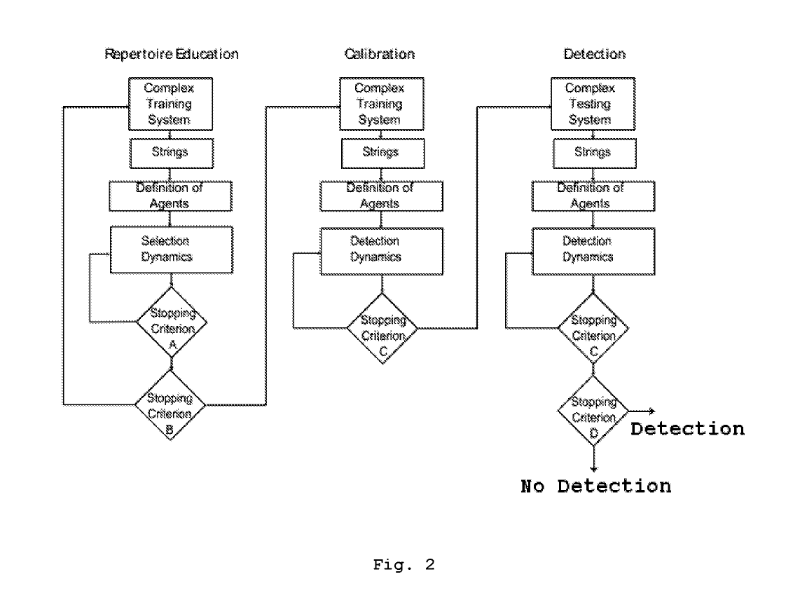

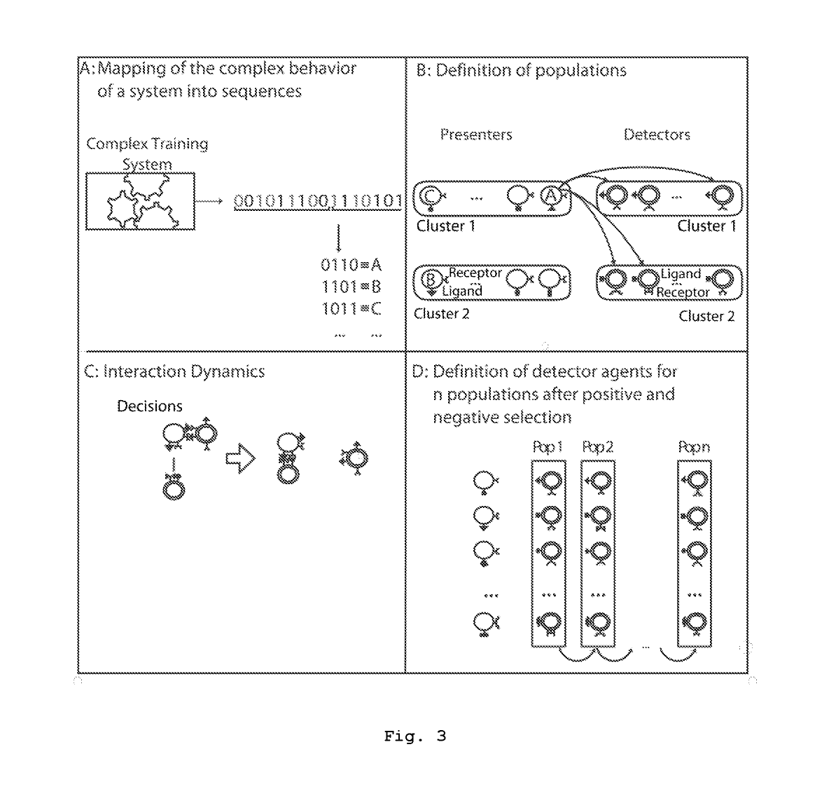

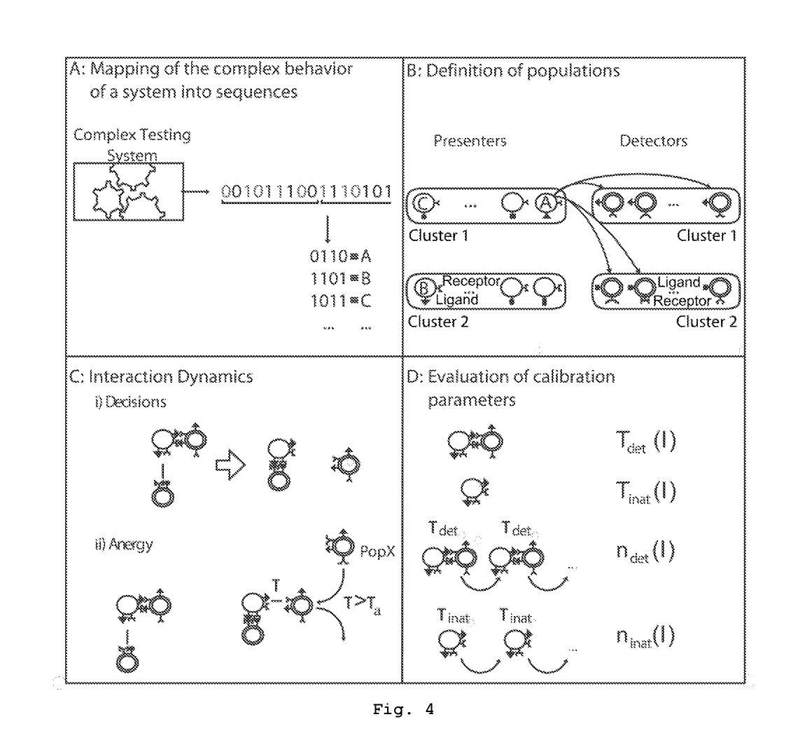

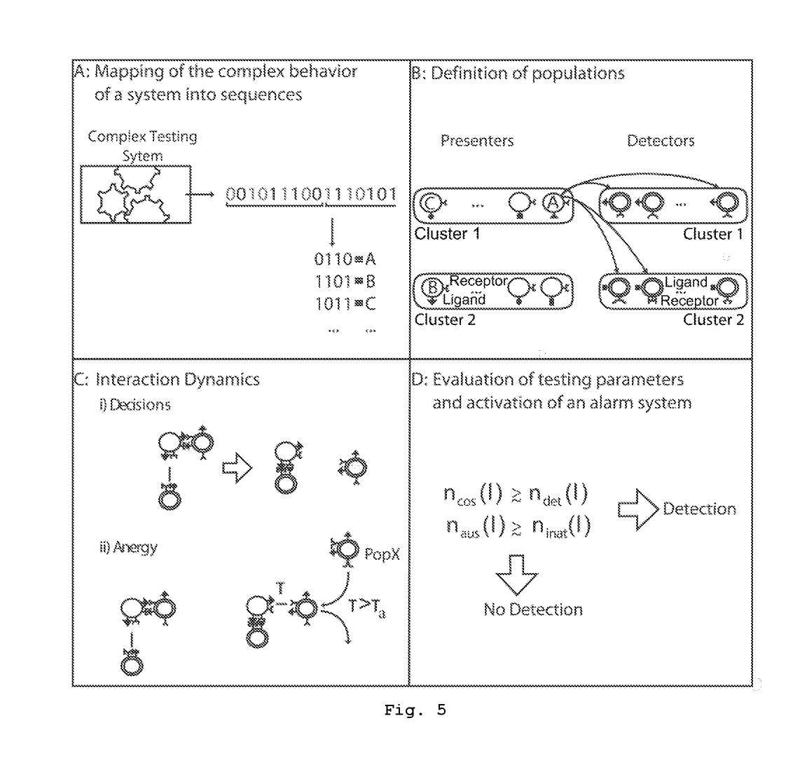

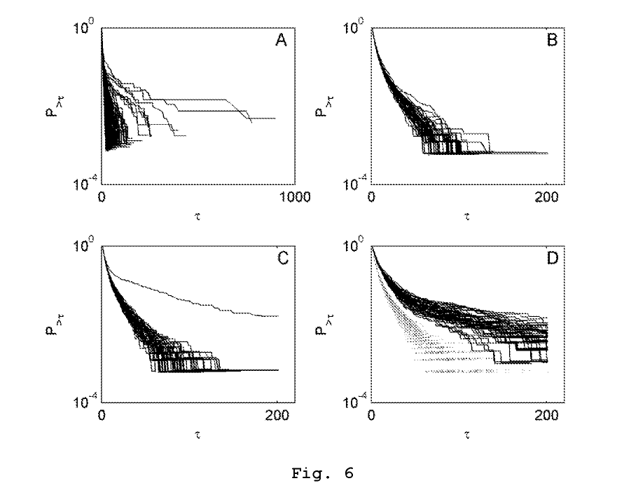

The method operates in three stages, education, calibration and detection (FIG. 1). In all of them the interaction dynamics between two types of agents—presenters and detectors—is analyzed.

The education stage uses a trial and error procedure to replace detector agents that have not been able to establish a pairing with a presenter agent (a mechanism designated by positive selection), or that establish pairings with presenter agents that are too stable (a mechanism designated by negative selection). These detector agents are replaced by others with a set of random features, as it will be defined below.

Positive selection increases the global interactivity of the several agents, making the dynamics more homogeneous. In that way maximal pairing lifetimes become representative of the population dynamics, so that negative selection will act over all agents simultaneously and not only over a subset. Negative selection maximizes frustration in respect to the information presented and by reducing pairing lifetimes between the two types of agents. The information related to sequences or combinations of sequences not present in the original signal do not influence the artificial system dynamics. As such, their appearance during the detection stage disturbs the dynamics leading to long pairing lifetimes which signal the presence of anomalies.

During the calibration stage the artificial system dynamics with educated detectors is analyzed to determine parameters that characterize the dynamics in the absence of anomalies. During the detection stage, the repertoire of educated detectors is used to build a population of detectors that interacts with presenter agents. Presenter agents are defined using the sequences of the digital signal to be tested. Given that the number of diverse detectors leading to the same maximally frustrated dynamics can be extremely large, detector agents are continuously replaced anytime they terminate pairings that are not necessarily too stable. This mechanism, called anergy, allows replacing detectors agents by other equivalent detectors contained in the repertoire. However, these detectors produce nevertheless a different dynamics in the presence of sequences, or combinations of sequences, that were not presented during the training (education) stage. In particular, a finite number of detectors can establish stable pairings. The number of stable pairings involving a presenter agent is called costimulation. Costimulation and anergy are used simultaneously to determine whether a presenter agent can establish stable pairings with many different detector agents, in which case the presence of anomalies is signaled, or whether the number of stable pairings it forms is small, and derives from interactions with a small number of badly educated detectors in the population.

### Definition of the Computational Model

The computational model establishes a set of interaction rules that each agent follows and which change its dynamical state. An agent is an element from a population of agents with the following attributes:
a ligand, which is a sequence of d digits.
a receptor, which can be defined as an ordered list of all sequences with d digits with whom the agent can interact with.
a connectivity list, which can be defined as the list of all agents with whom the agent can interact with.

Each agent can be associated to a state that registers whether the agent is paired or not. In case it is paired, the agent's state records the agent it is paired with.

All agents, presenters and detectors, use the same interaction rules to pair with agents of the other type and presenting ligands which are preferably on the upper positions of their receptor's lists.

Anytime two agents of opposite type interact, a new pair is formed if both ligands are preferred relatively to the ligands displayed by the agents to those agents are paired with (in case they were previously paired). In that case, previous pairings are terminated. In case one agent is not paired, it will form a pair with any agent of the opposite type listed in its connectivity list and provided its ligand is preferred by the other agent's receptor. These interaction rules assume that each agent can only establish a stable pair with one agent at a time.

Ordered receptor's lists can be defined implicitly or explicitly. Implicit orderings can be established using one parameter functions—such as random number generators—relating a score to each sequence. The explicit ordered list can be obtained by ordering the scores associated to each sequence. Different and diverse lists can be obtained by changing the function parameter—the seed number in the random number generator. The invention achieves qualitatively equivalent results using either an explicit or implicit lists definition.

### Computational Algorithm

The implementation of the computational algorithm assumes that N sequences obtained from a digital signal describing the behavior of the target system are provided, and that any sequence can be mapped onto a finite subset of natural numbers (FIG. 3A). Hence, hereafter a sequence or its corresponding natural number can be referred to indistinctively. The most frequent sequences are selected and distributed among a finite number of 2 or more groups (or ‘clusters’), Nc, and presented by presenter agents (FIG. 3B). For example, considering a sample with W sequences taken from a digital signal, it may be decided to select to present only sequences appearing in a sample two or more times, each sequence being assigned a cluster with a number equal to the remain of the integer division of the sequence number by Nc. Alternatively, the digital signal can be divided in Nc subsamples with the same dimension, possibly obtained using bootstrapping, and from which are excluded sequences with a single occurrence—not statistically relevant. Presenter agents from the first cluster would present sequences in the first subsample, their number would be proportional to their frequency and they would be ordered according to their score. Designating by Ns the total number of possible sequences, presenter agents in the second cluster present sequences from the second subsample with their scores added by Ns, keeping their frequency of occurrence and ordering according to their score. The procedure is iterated to the other clusters.

The algorithm is divided in three stages: repertoire education (FIG. 3), calibration (FIG. 4) and anomaly detection (FIG. 5). During the education stage typical pairing lifetimes are reduced, as shown in FIG. 6, for a typical realization, in A in the beginning and in B in the end of the education process. This typical realization considered populations with 60 presenter agents and 60 detector agents, and maximal connectivity. Each detector agent presented a different sequence corresponding to an arbitrarily chosen number between 1 and 1000. The plots presented in FIGS. 6A e 6B were obtained after running for 10000 iterations the interaction dynamics. Similar results can be obtained for any other number of agents while keeping the connectivity equal to 60.

The calibration stage uses the populations of detector agents obtained in the end of the education process, to establish parameters characterizing the usual dynamics of the interacting agents.

During the detection stage characteristic pairing lifetimes increase considerably relatively to the values found in the calibration stage whenever a sequence is presented that was never presented during the education stage. FIG. 6C shows a typical realization, where an agent from the previous system presented a number that was not presented during education (nonself sequence). The line that is clearly apart from the others corresponds to its dynamics and shows how that agent establishes longer pairings more frequently. The characteristic pairing lifetimes also increase considerably when an unfamiliar combination of sequences that have already been presented, as shown in FIG. 6D. This typical realization corresponds to a system with 60 presenter agents and 60 detector agents, connectivity 30, and when presenter agents presented in turns, either a random number between 1 and 1000, or between 1001 and 2000. When presenter agents present one of these sets of numbers, the dynamics produces connection times as illustrated by the lighter dots, while dark dots are results when one set of presenters presents the numbers below 1001, and the other set present the numbers they presented above 1000.

### Repertoire Education

### Step 1E: Initialization of Detector Agents

To each detector agent is associated:
an integer index I, the agent identifier, different for each detector agent and ranging from 1 to the number of different detector agents.
an integer index C, group (‘cluster’) identifier, taken from a uniform distribution between 1 and Nc.
a ligand L, equal to the cluster index C.
a receptor, to which it corresponds an ordered list R, with the ligands with which the agent can interact and which is initially random.
a connectivity list K, where all agent's identifiers with whom the agent can interact with are listed and which is initially random.
a state E, initially set to zero corresponding to a configuration where agents are not paired.

### Step 2E: Initialization of Presenter Agents

To each presenter agent is associated:
an integer index I, the agent identifier, different for each presenter agent and ranging from 1 to the number of different presenter agents.
an integer index C, group (‘cluster’) identifier, defined from the sequence presented (for instance, it could be the remain of the integer division of the score and Nc).
a ligand L, equal to the score corresponding to the sequence presented.
a receptor, to which it corresponds an ordered list R, with Nc integer numbers. All presenter agents in the same cluster C have identical lists. The sequence at the ith position in the list has the associated score R(i)=C+i−1 (mod Nc), i=1, . . . , Nc.
a connectivity list K, where all agent's identifiers with whom the agent can interact with are listed and which is consistent with the connectivity list defined for detector agents, i.e., ensuring that presenter agents in detectors' connectivity lists, have in their connectivity lists those detector agents.
a state E, initially set to zero corresponding to a configuration where agents are not paired.

### Step 3E: Initialization of Other Relevant Registers

Registers storing information concerning the duration of pairings for each agent and the time each agent spent without establishing pairings, are set to zero.

### Step 4E: Interactions Among Agents

Pairs of presenter and detector agents with ligands in their corresponding connectivity lists are put in interaction. Denote by i and j their identifier indices and by p(j,i) the rank of the ligand presented by agent j in the receptor list of agent i. Agents i and j form a new pair:
i) if E(j)≠0 [symbol] E(i)≠0 [symbol] p(i,j)<p(E(j),j) [symbol] p(j,i)<p(E(i),i), and then E(E(j))→0, E(E(i))→0, E(j)→i, E(i)→j and register the number of iterations during which pairs (i, E(i)) and (j,E(j)) remained paired.
ii) if E(j)=0 [symbol] E(i)≠0 [symbol] p(j,i)<p(E(i),i) and then E(E(i))→0, E(j)→i, E(i)→j and register the number of iterations during which pair (i, E(i)) remained paired and the number of iterations during which agent j remained not paired.
iii) if E(i)=0 [symbol] E(j)≠0 [symbol] p(i,j)<p(E(j),j) and then E(E(j))→0, E(i)→j, E(j)→i and register the number of iterations during which pair (j, E(j)) remained paired and the number of iterations during which agent i remained not paired.
iv) if E(i)=0 [symbol] E(j)=0 then E(i)→j, E(j)→i and register the number of iterations during which agents i e j remain not paired.

### Step 5E: Positive Selection

Connectivity and receptor lists and cluster indices of detector agents not forming pairs for a time larger to a number of iterations larger than τₚₒₛ—designated positive selection time—are replaced by new randomly drawn items, the connectivity list K and the cluster index C and the agent's state E is set to zero.

In case no detector agents satisfy the previous condition, the positive selection threshold time τₚₒₛ is updated to the largest duration time a detector agent remained without establishing pairings in the last W iterations.

### Step 6E: Negative Selection

Connectivity and receptor lists of detector agents remaining paired for a number of iterations larger than τ_{neg}—designated negative selection time—are replaced by new randomly drawn lists, as for example the receptor list R, and the states of the paired agents are set to zero.

In case no detector agents satisfy the previous condition, the negative selection threshold time τ_{neg} is updated to the largest duration time a detector agent remained paired. The population of detector agents is recorded.

### Step 7E: Updates and Outputs

Increment the iteration number by one and in case it does not exceed a maximum value, return to STEP 4. If not, terminate the education process. Register the last selected population of detectors and add it to the repertoire of educated detectors.

### Step 8E: Repertoire Expansion

The repertoire of educated detectors agents should be enlarged by repeating the previous procedure several times (typically a number of times larger than 10) using different random number generations. Steps 5E and 6E can be modified in order to take into account the definition of the first population of educated agents. In that case step 6E* should be used instead:

### Step 6E*: Negative Education

Receptor lists of detector agents remaining paired for a time larger than the number of iterations τ_{neg}—designated negative selection time—are randomly reshuffled, for example it is maintained the cluster index C and replaced the receptor list R by a random permutation and the states of the paired agents are set to zero.

In case no detector agents satisfy the previous condition, the negative selection time τ_{neg} is updated to the largest duration time a detector agent remained paired. The population of detector agents is recorded.

In the end of the education process several educated populations are registered. The several detector agents with the same identifier index I in each population have the same index C and the same connectivity lists K.

### Alternative Algorithm

An important modification consists in changing every J iterations sequences presented by presenter agents. In that case, before reaching the final iteration, step 7E calls step 2E. All registers are reinitialized and the population of presenter agents is defined according to the new sequences to be presented. Detector agents are kept, so that those remaining in the population maximize frustration for several sets of sequences presented by presenter agents.

Another modification that improves the algorithm convergence consists in stopping to change connectivity lists after a given iteration (for instance, during the second half of the average number of iterations required to educate a population), in which case step 5E is omitted as well as the modification in the connectivity list in step 6E.

### Anomaly Detection

To perform monitoring and anomaly detection, the algorithm requires two additional stages after education, namely calibration and testing. The calibration stage is needed to find parameters characterizing the normal behavior of the system. In this stage the same sequences that were presented during the education stage are used, to produce operating conditions in the absence of anomalies. The detection stage uses sequences taken from a signal to be tested.

### Calibration Stage

### Step 1C: Initialization of Detector Agents

A population of detector agents in the repertoire is selected and agent's states are set to zero.

### Step 2C: Initialization of Presenter Agents

A population of presenter agents is defined as in step 2E, using sequences from a training signal.

### Step 3C: Registers Initialization

Proceed as in step 3E.

### Step 4C: Interactions Among Agents

Proceed as in step 4E.

### Step 5C: Anergy

Whenever a detector agent terminates a pairing without starting a new one, the detector agent is replaced by another agent with the same identifier in another randomly drawn population in the repertoire.

### Step 6C: Stopping Condition I

The iterative process is repeated after step 3C (or 2C, as in the alternative algorithm described above where presented sequences change) until the final iteration is reached.

### Step 7C: Determination of Characteristic Times

For each presenter agent with identifier I, the time duration τ_{det}(I) is calculated, for which a fraction p (for instance, p=99%) of pairings lasted a shorter time. The time duration τᵢₙₐₜ(I) is also calculated, for which a fraction p (for example, p=99%) of periods of time in which the agent did not establish a pairing, lasted a shorter time. The number of events with these time durations are also registered, respectively, n_{det}(I) and nᵢₙₐₜ(I).

### Step 8C: Stopping Condition II

The previous procedure is repeated starting from step 1C and for a statistically significant number of times, nᵣ (for example, 20). All time durations, τ_{det}(I) and τ_{inac}(I), and corresponding number of events, n_{det}(I) e n_{inac} (I), are successively recorded.

### Step 9C: Calculation of Normality Parameters

For each agent, the characteristic time durations, T_{det}(I) and Tᵢₙₐₜ(I), are defined, for which a percentage q (for example q=5%) of the values τ_{det}(I) and τᵢₙₐₜ(I) are larger. Record as well the number of occurrences n_{det}(I) and nᵢₙₐₜ(I) for those values.

### Anomaly Detection Algorithm

### Step 1D: Initialization of Detector Agents

Proceed as in step 1C.

### Step 2D: Initialization of Presenter Agents

Proceed as in step 2E, with sequences taken from the signal to be tested.

### Step 3D: Initialization of Other Registers

Proceed as in step 3E.

### Step 4D: Interactions Among Agents

Proceed as in step 4E.

### Step 5D: Anergy

Proceed as in step 5C.

### Step 6D: Costimulation

Increment n_{cos}(I) whenever a presenter agent I is involved in a pairing lasting longer than T_{det}(I) iterations.

### Step 7D: Inactivity

Whenever a detector agent stays without forming new pairings for Tᵢₙₐₜ(I) iterations, a inactivity counter nₐᵤₛ(I) (absence of contacts) from the presenter agent is incremented.

### Step 8D: Activation of Agents

The iterative process is repeated starting from step 3D (or from step 2D, if the sequences presented change as assumed in the alternative algorithm described above) until the maximum pre-defined iteration is achieved (equal to the final iteration mentioned in step 6C). It is considered that agents are activated by other agents if n_{cos}(I)−n_{det}(I)−ε>0. It is considered that agents are activated due to a lack of interactions with other agents if nₐᵤₛ(I)−n_{inac}(I)−ε′>0. ε and ε′ are constants greater or equal to zero, which can be used to decrease the impact of stochastic fluctuations on the activation of agents in the absence of anomalies (false positive errors).

### Step 9D: Activation of the Anomaly Alarm System

The alarm system is activated when one or more agents are activated.

The present invention can find applications in all areas where an anomalous behavior in systems with high complexity needs to be detected. The following areas of application are possible:
computer security: to detect intrusions in software with malicious intentions.
genome and proteome analysis: to detect abnormal sequences.
spectral chemical composition analysis: to detect the presence of unwanted substances in a sample or for quality control.
clinical diagnosis, for instance, in clinical imaging.

In a realization of the present invention the formulation of the invention is characterized by using always a computational algorithm to detect anomalies in the presentation of a plurality of sequences describing the typical behavior of the system to be monitored, these anomalies being detected due to a decrease in frustration in the dynamics of the computational system and possibly occur when a sequence was never observed in the typical behavior of the system or when sequences have never been observed together but are used during the typical behavior of the system.

In a realization of the present invention the formulation of the computational algorithm is characterized by the definition of a frustrated dynamics among agents, with one set of agents presenting the sequences from the signal describing the system's behavior, and the other set using this information to decide to which agent it will remain paired.

In a realization of the present invention the anomaly detection mechanism is characterized for using as abnormality criterion the computational agents pairing duration times and also the time duration during which they cannot form pairs.

In a realization of the present invention the formulation of the computational algorithm is characterized for defining interaction rules among agents such that all agents attempt to form pairs with agents randomly selected from a list defining their connectivity, for forming a new pair whenever they are not paired or whenever the new agent with which they interact is placed higher in a list defining its receptor, and provided the other agent they interact with acts in the same way.

In a realization of the present invention the formulation of the computational algorithm is characterized for using an education stage to build a repertoire of detector agents, during which detector agents are eliminated and replaced by new ones, whenever they remain not paired during a time larger than a continuously optimized characteristic positive selection time, or whenever they establish pairings that last longer than a continuously optimized characteristic negative selection time.

In a realization of the present invention the formulation of the computational algorithm is characterized for using during the education stage presenter agents that present sequences characterizing the typical behavior of the system under analysis.

In a realization of the present invention the formulation of the computational algorithm is characterized for defining after the education stage and for each agent, a profile of the number of pairings each agent formed and as a function of their time duration.

In a realization of the present invention the formulation of the computational algorithm is characterized for defining after the education stage and for each agent, a profile of the number of periods of time each agent remained not paired and as a function of the time duration. In a realization of the present invention the formulation of the computational algorithm is characterized for using during the monitoring phase presenter agents that present sequences characterizing the typical behavior of the system to monitor.

In a realization of the present invention the formulation of the computational algorithm is characterized for using a mechanism of anergy in the monitoring stage, where paired detector agents that are abandoned as a result of the computational system frustrated dynamics, are replaced by another equivalent detector agent in the repertoire formed during the education stage.

In a realization of the present invention the formulation of the computational algorithm is characterized for using a costimulation mechanism establishing that during a time interval presenter agents establishing a number of long pairings greater than a certain typical number, defined above, are activated.

In a realization of the present invention the formulation of the computational algorithm is characterized for using a mechanism of neglect establishing that during a time interval presenter agents not establishing pairings for a number of times greater than a certain typical number, defined above, are activated.

In a realization of the present invention the formulation of the computational algorithm establishes, after the education stage, the number of agents that can be activated by the presentation of sequences obtained from samples encoding the typical behavior of the system.

In a realization of the present invention the formulation of the computational algorithm establishes that a sample exhibits an anomaly if the number of activated presenter agents is greater than established before.

The preferred embodiments described above can obviously be combined. The following claims define additional preferred embodiments of the present invention.

1. A method for the detection of anomalous sequences in a digital signal to be tested as compared to an initial digital signal, divided in three stages designated by repertoire education, calibration and detection, wherein:
using agents, and where each agent comprises:
1) a sequence with d digits, referred to as a ligand;
2) a list with a plurality of sequences with d digits, referred to as a receptor;
3) a state, indicating when it is off, in which case the agent is said to be alone, or if it is on, in which case with another agent it is said to be paired;
4) a connectivity list, in which is listed a selection of other agents with which the agent can interact;
Comprising the following steps:
a) initializing a population of presenter agents each one from a set of sequences taken from a pre-established number of sequences defined from a training digital signal, during the education and calibration stages, or from a signal to be tested, in the detection stage;
b) initializing a population of detector agents;
c) during a time to be established, it is done:
i) interacting between presenter and detector agents;
ii) replacing detector agents that do not form pairs after a pre-established time, calling this action a positive selection and applying it during the education of the first population to be included in the detection repertoire;
iii) replacing detector agents that are paired a presenter agent for a time longer than a pre-established time, calling this action as a negative selection and applying it during the education of the repertoire;
iv) replacing detector agents terminating pairings longer than a pre-established time duration and not forming a new pairing, by other equivalent detector agents in the repertoire, calling this action anergy and applying it during the calibration and anomaly detection;
d) adding the educated population of detector agents to a repertoire of detector agents during the repertoire education stage;
e) detecting any possible increase in the duration and number of long pairings between presenter and detector agents and/or any possible increase in the duration and number of times detector agents are not paired, signaling the presence of anomalous sequences or anomalous combinations of known sequences;
and for the said interaction pairing agents of the opposite types:
a′) when two agents are not paired, whenever for both agents the other agent's ligand is listed in its receptor;
b′) when an agent is not paired and the other is paired, whenever in the receptor of the agent that is not paired is the other agent's ligand, and the receptor of the paired agent prefers the ligand of the agent not paired to the ligand of agent to which it is paired;
c′) when two agents are already paired, whenever for both agents their receptors prefer the ligand of the other agent to the ligand of the agent to which they are paired.

2. A method according to claim 1, wherein repeating steps from a) to c) a predefined number of times, and in each case, adding a population of the obtained detector agents in a repertoire of educated detector agents.

3. A method according to claim 1, wherein the initialization of a population of detector agents comprising for each detector agent:
a) the assignment of a cluster, denoted C, being C a random integer between 1 and the number of clusters, denoted Nc;
b) the initialization of a ligand to the number assigned to the cluster;
c) the initialization of a receptor with an ordered list of randomly distributed ligands;
d) the initialization of a connectivity list with a random list of presenter agents;
e) the initialization of the agent's state to zero.

4. A method according to claim 1, wherein the initialization of a population of presenter agents comprising for each presenter agent:
a) the assignment of a cluster, denoted C, defined from the template sequences presented by this presenter agent, being C an integer between 1 and the number of clusters, denoted Nc;
b) the initialization of the ligand with a template sequence associated to this presenter agent;
c) the initialization of the receptor with an ordered list R(i) using the rule R(i)=C+i−1 (mod Nc), being i an integer between 1 and Nc;
d) the initialization of the connectivity list as a ordered list of all detector agents in which connectivity lists the present presenter agent;
e) the initialization of the agent's state as off.

5. A method according to claim 1
comprising for each agent:
a) the initialization and recording of the time duration during which the agent's pairing remains unchanged;
b) the initialization and recording of the time duration during which the agent remains unpaired.

6. A method according to claim 1, wherein in the positive selection, a detector agent is replaced by another identical detector agent but where it is replaced:
a) its receptor;
b) its connectivity list;
c) its cluster C.

7. A method according to claim 1, wherein updating the pre-established positive selection time used in positive selection to the largest time duration, a detector agent remained not paired in a recent previously established period of time, whenever no agents verify the positive selection elimination condition.

8. A method according to claim 1, wherein when eliminated by negative selection, a detector agent is replaced by another identical detector agent where it is replaced:
a) its receptor;
b) its connectivity list;
c) its state to off, as well as that of the agent it was paired with.

9. A method according to claim 1, wherein updating the negative selection predefined time used in the negative selection condition, to the largest time duration a detector agent remained paired, whenever no agents verify the negative selection elimination condition.

10. A method according to claim 2, wherein during negative selection, the detector agent being replaced by another identical detector agent for which:
a) its receptor is replaced by a list given by a random permutation of the list to be replaced;
b) its state is turned off, as well as that of the agent it was paired with.

11. A method according to claim 1, wherein on step c), at each pre-established period of time, the population of presenter agents is reinitialized, being each agent reinitialized from a new template sequence with a pre-established number of sequences taken from the digital training signal.

12. A method according to claim 1, wherein one or more time durations being defined by the number of iterations performed at a given iteration of the method.

13. A method according to claim 12 characterized for detecting possible increases in pairing lifetimes between presenter and detector agents and/or possible increases in the time detector agents spent unpaired, by comparing these time durations to values obtained after executing the method with a testing and a training signal.

14. A method according to claim 13, wherein using in the mentioned comparison a constant parameter, ε, threshold, predefined to reduce false positive errors.

15. A computer program comprising the computer code required to accomplish the steps involved in the preferred method when the given program is run in a data processing system.

16. A computer readable medium incorporating the previous computer program.

17. A data processing system for the detection of anomalous sequences in a digital signal to be tested and compared to a training digital signal characterized by being configured to execute the method of claim 1.

18. A method according to claim 2, wherein the initialization of a population of detector agents comprising for each detector agent:
a) the assignment of a cluster, denoted C, being C a random integer between 1 and the number of clusters, denoted Nc;
b) the initialization of a ligand to the number assigned to the cluster;
c) the initialization of a receptor with an ordered list of randomly distributed ligands;
d) the initialization of a connectivity list with a random list of presenter agents;
e) the initialization of the agent's state to zero.

19. A method according to claim 2, wherein the initialization of a population of presenter agents comprising for each presenter agent:
a) the assignment of a cluster, denoted C, defined from the template sequences presented by this presenter agent, being C an integer between 1 and the number of clusters, denoted Nc;
b) the initialization of the ligand with a template sequence associated to this presenter agent;
c) the initialization of the receptor with an ordered list R(i) using the rule R(i)=C+i−1 (mod Nc), being i an integer between 1 and Nc;
d) the initialization of the connectivity list as a ordered list of all detector agents in which connectivity lists the present presenter agent;
e) the initialization of the agent's state as off.

20. A method according to claim 2 comprising for each agent:
a) the initialization and recording of the time duration during which the agent's pairing remains unchanged;
b) the initialization and recording of the time duration during which the agent remains unpaired.
